(19) United States
(12) Patent Application Publication
(10) Pub. No.: US 2025/0200171 A1
(43) Pub. Date: Jun. 19, 2025

(54) Security enablement for hosted software applications

(71) Applicant: Orchid Security Inc., New York, NY (US)

(72) Inventors: Roy Katmor, Zikhron Yaakov (IL); Ido Kelson, Tel Aviv (IL); Robert Wiseman, Tel Aviv (IL)

(21) Appl. No.: 18/964,739

(22) Filed: Dec. 2, 2024

Related U.S. Application Data
(60) Provisional application No. 63/609,381, filed on Dec. 13, 2023.

(51) Int. Cl. G06F 21/54; G06F 21/31; G06F 21/57

(52) U.S. Cl. CPC G06F 21/54; G06F 21/31; G06F 21/577

(57) ABSTRACT

Methods, storage systems and computer program products implement embodiments of the present invention that include specifying a security feature for a software application including application instructions, and then analyzing the software application so as to identify a given application instruction for modification so as to implement the security feature. In response to analyzing the software application, the specified security feature is implemented by modifying the identified application instruction. Finally, execution of the software application with the modified application instruction is initiated so as to perform the specified security feature.

### CROSS-REFERENCE TO RELATED APPLICATION

This application claims the benefit of U.S. Provisional Patent Application 63/609,381, filed Dec. 13, 2023, which is incorporated herein by reference

### FIELD OF THE INVENTION

The present invention relates generally to computer security, and specifically to adding security features to legacy hosted software applications.

### BACKGROUND OF THE INVENTION

System and Organization Controls 2 (SOC 2) is a framework for assessing and reporting on the security, availability, processing integrity, confidentiality, and privacy of an organization's systems and processes. It is commonly used to evaluate the security controls and practices of service providers, particularly those in the technology and cloud computing industries. When it comes to hosted software applications, achieving SOC 2 compliance can be challenging (i.e., compared to newer systems) due to their potential limitations and outdated technology. Additionally, since security requirements can change over time, keeping hosted software applications compliant with these requirements may require significant engineering resources that are not always available to organizations using these applications.

### SUMMARY OF THE INVENTION

There is provided, in accordance with an embodiment of the present invention, a method, including specifying a security feature for a software application including application instructions, analyzing the software application so as to identify a given application instruction for modification so as to implement the security feature, implementing, by a processor in response to analyzing the software application, the specified security feature by modifying the identified application instruction, and initiating execution of the software application with the modified application instruction.

In one embodiment, modifying the identified application instruction includes hooking the identified application instruction so as to call code implementing the specified security feature.

In a first hooking embodiment, hooking the identified application instruction includes deploying a hooked method to the software application.

In a second hooking embodiment, deploying the hooked version of the given application instruction includes injecting a class to the software application.

In another embodiment, the steps of analyzing the software application and modifying the given instruction are performed by an application wrapper executing on the processor.

In some embodiments, the software application and the application wrapper execute on a first computer including the processor, and wherein the code implementing the specified security feature executes on a second computer.

In a first analysis embodiment, analyzing the software application includes performing a static analysis of the application instructions.

In a second analysis embodiment, analyzing the software application includes performing a dynamic analysis of the application instructions.

In a third analysis embodiment, analyzing the software application includes performing a guided analysis of the application instructions.

In an additional embodiment, implementing the security feature includes modifying, by the processor in response to analyzing the software application, the identified application instruction so to add as authentication to the software application.

In a first authentical embodiment, adding the authentication includes modifying, by the processor in response to analyzing the software application, the identified application instruction so as to add a login operation to the software application.

In a second authentical embodiment, adding the authentication includes modifying, by the processor in response to analyzing the software application, the identified application instruction so as to integrate an identity provider (IDP) system with the software application.

In a third authentical embodiment, adding the authentication includes modifying, by the processor in response to analyzing the software application, the identified application instruction so as to add multi factor authentication (MFA) to the software application.

In a fourth authentical embodiment, adding the authentication includes modifying, by the processor in response to analyzing the software application, the identified application instruction so as to add single sign-on (SSO) to the software application.

In a fifth authentical embodiment, adding the authentication includes modifying, by the processor in response to analyzing the software application, the identified application instruction so as to add passwordless authentication to the software application.

In a sixth authentical embodiment, adding the authentication includes modifying, by the processor in response to analyzing the software application, the identified application instruction so as to add Identity Governance and Administration (IGA) to the software application.

In a seventh authentical embodiment, adding the authentication includes modifying, by the processor in response to analyzing the software application, the identified application instruction so as to add password strength enforcement to the software application.

In a further embodiment, implementing the security feature includes modifying, by the processor in response to analyzing the software application, the identified application instruction so as to add authorization to the software application.

In a first authorization embodiment, adding the authorization includes modifying, by the processor in response to analyzing the software application, the identified application instruction so as to add access control to the software application.

In a first access control embodiment, adding the access control includes modifying, by the processor in response to analyzing the software application, the identified application instruction so as to add role-based access control (RBAC) to the software application.

In a second access control embodiment, adding the access control includes modifying, by the processor in response to analyzing the software application, the identified application instruction so as to add attribute-based access control (ABAC) to the software application.

In a second authorization embodiment, wherein adding the authorization includes modifying, by the processor in response to analyzing the software application, the identified application instruction so as to add just-in-time access functionality to the software application.

In a supplemental embodiment, implementing the security feature includes modifying, by the processor in response to analyzing the software application, the identified application instruction so as to add, to the software application one or more keys for encryption.

In a first encryption embodiment, adding the one or more keys for encryption includes modifying, by the processor in response to analyzing the software application, the identified application instruction so as to add rotating the keys to the software application.

In a second encryption embodiment, wherein adding the one or more keys for encryption includes modifying, by the processor in response to analyzing the software application, the identified application instruction so as to add changing a size of a given key to the software application.

In a third encryption embodiment, wherein adding the one or more keys for encryption includes modifying, by the processor in response to analyzing the software application, the identified application instruction so as to bring your own key (BYOK) encryption to the software application.

In an additional embodiment, implementing the security feature includes modifying, by the processor in response to analyzing the software application, the identified application instruction so as to connect to a privileged access management (PAM) service.

In a further embodiment, identify a given application instruction includes identifying a lack of such an application instruction, and wherein modifying the application instruction includes adding an additional application instruction to the software application.

There is also provided, in accordance with an embodiment of the present invention, an apparatus including a memory configured to store software a application including application instructions, and a processor configured to specify a security feature for the software application, to analyze the software application so as to identify a given application instruction for modification so as to implement the security feature, to implement, in response to analyzing the software application, the specified security feature by modifying the identified application instruction, and to initiate execution of the software application with the modified application instruction.

There is additionally provided, in accordance with an embodiment of the present invention, a computer software product, the computer software product including a non-transitory computer-readable medium, in which program instructions are stored, which instructions, when read by a computer, cause the computer, to specify a security feature for a software application including application instructions, to analyze the software application so as to identify a given application instruction for modification so as to implement the security feature, to implement, in response to analyzing the software application, the specified security feature by modifying the identified application instruction, and to initiate execution of the software application with the modified application instruction.

### BRIEF DESCRIPTION OF THE DRAWINGS

The disclosure is herein described, by way of example only, with reference to the accompanying drawings, wherein:

FIG. 1 is a block diagram showing an example of a host computer that can communicate with a management server and a security resource server so as to dynamically add a security feature to a hosted software application, in accordance with an embodiment of the present invention;

FIG. 2 is a block diagram showing a configuration of the host computer, in accordance with an embodiment of the present invention;

FIG. 3 is a block diagram showing a configuration of the management server, in accordance with an embodiment of the present invention;

FIG. 4 is a flow diagram that schematically illustrates a method of analyzing the hosted software application, in accordance with an embodiment of the present invention; and

FIG. 5 is a flow diagram that schematically illustrates a method of executing the hosted software application with the security feature, in accordance with an embodiment of the present invention.

### DETAILED DESCRIPTION OF EMBODIMENTS

Embodiments of the present invention provide methods and systems for adding security features to a hosted software application comprising a set of application instructions. As described hereinbelow, a security feature for a software application is specified. For example, the security feature may comprise authentication, authorization, encryption or privileged access management.

The application instructions of the software application can be analyzed so as to identify a given application instruction (or a lack of such instruction), for modification or augmentation respectively so as to implement the security feature. Upon detecting the given application instruction, a modified version of the given application instruction can be deployed so as to implement the security feature. In embodiments described herein, deploying the hooked version of the given application instruction may comprise deploying a hooked method to the software application. Additionally or alternatively, deploying the hooked version of the given application instruction may comprise injecting a class into the hosted application during execution.

Finally, the software application can be executed with the modified application instruction, thereby incorporating the specified security feature into the application once the modified application instruction is executed.

In some embodiments, an application wrapper executing alongside the hosted software application may perform the analysis and deploy a hooked version of the given application so as to implement additional security features by augmenting and/or replacing functionality of the hosted software application. This enables systems implementing embodiments of the present invention to incorporate security features into a hosted software application without making any changes to the deployed code of the hosted software application. In these embodiments, augmenting functionality may comprise detecting that a given security feature (e.g., password protection) is missing from a given hosted software application, and then adding the given security feature to the given hosted software application.

### System Description

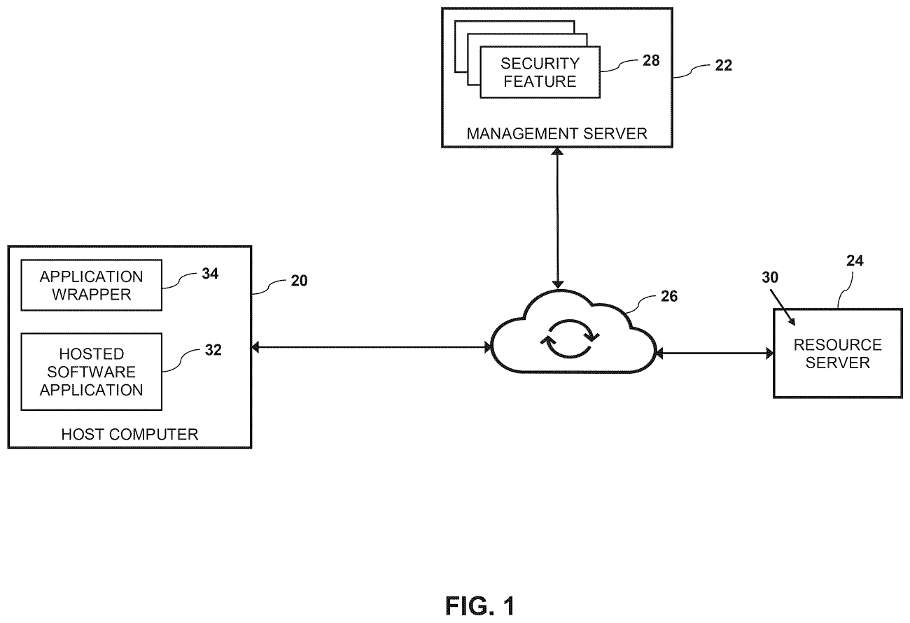

FIG. 1 is a block diagram showing a host computer 20 that can communicate with a management server 22 (i.e., a computer) and an external resource server 24 via a public network such as Internet 26, in accordance with an embodiment of the present invention. In the configuration shown in FIG. 1, management server 22 comprises a set of security features 28, such as authorization, authentication and encryption that can be provided by a security service 30 executing on resource server 24.

Using embodiments described hereinbelow, host computer 20 is configured to execute a hosted software application 32 and an application wrapper 34 (also known as a service or a daemon) that, as described hereinbelow, can be configured to analyze the hosted software application and to seamlessly add a given security feature 28 to the hosted software application.

In some embodiments, hosted software application 32 may comprise an internally developed (e.g., a legacy application) application or a third-party software application that is used by an organization, and that the organization hosts on its servers (e.g., management server 22) or in a managed cloud service such as AMAZON WEB SERVICES™ (AWS™), provided by AMAZON. COM, INC., 410 Terry Avenue North Seattle, WA 98109 USA. In these embodiments, software application 32 may not include desired contemporary security features.

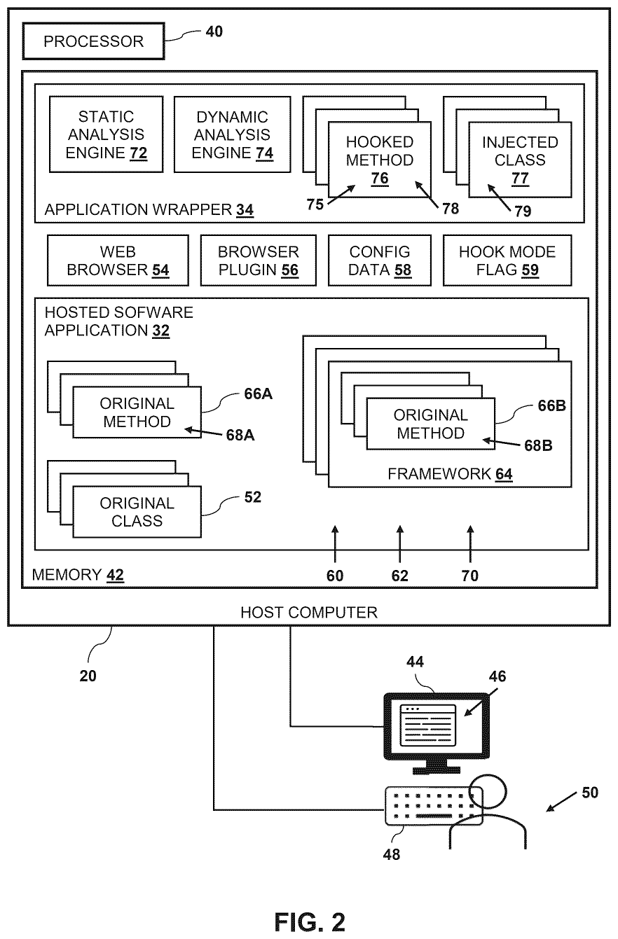

FIG. 2 is a block diagram showing an example of a configuration of host computer 20, in accordance with an embodiment of the present invention. In the configuration shown in FIG. 2, host computer 20 comprises a host processor 40, a host memory 42, a display 44 that is configured to present rendering 46, and a input device such as keyboard 48 that is configured to accept input from a user 50.

In some embodiments, memory 42 comprises hosted software application 32, application wrapper 34, a web browser (e.g., CHROME™) 54, a browser plugin 56, configuration data 58, and a hook mode flag 59. Wrapper 34 is a software layer or a program designed to “wrap” around hosted software application 32 so as to modify or extend its behavior without altering its core code. In embodiments herein, wrapper 34 can act as an interface between software application 32 and security features 28.

As described hereinbelow, browser plugin 56 can be used for a guided user/administrator analysis of hosted software application 32, and configuration data 58 can be used by application wrapper 34 to dynamically enable a given security feature 28 in the hosted software application.

Hosted software application 32 has an application ID 60 and comprises application instructions 62 (e.g., program instructions such as JAVA™ or C# bytecode and PYTHON source code), a framework 64 that comprises a set of original methods (i.e., functions) 66 having respective original method names 68, and a set of original classes 52. In FIG. 2, original methods 66 and original method names 68 can be differentiated by appending a letter to the identifying numeral, so that the original methods comprise original methods 66A having respective original method names 68A and original methods 66B having respective original method names 68B. In embodiments described herein, hosted software application 32 comprises original methods 66A and framework 64 comprises original methods 66B.

Application instructions 62 typically comprise one or more classes 52, original methods 66 and one or more calls 70 to original methods 66. Examples of application instructions 62 include, but are not limited to, Java or C# bytecode and PYTHON (source) code. An example of framework 64 comprises the SPRING FRAMEWORK for JAVA™.

Application wrapper 34 comprises a static analysis engine 72, and a dynamic analysis engine 74. As described hereinbelow, processor 40 can execute static analysis engine 72 so as to perform a static analysis of application instructions 62. Processor 40 can also execute dynamic analysis engine 74 that can use techniques such as instrumentation and reflection analysis so as to analyze hosted software application 32 while the host processor executes instructions 62.

In embodiments of the present invention, application wrapper 34 also comprises one or more hooked methods 76 having respective hooked method names 78 and hooked instructions 75. In some embodiments, each hooked method 76 having a given hooked method name 78 has a corresponding original method 66 with an identical original method name 68. In these embodiments, a given hooked method 76 will take precedence over the corresponding original method 66 when application instructions 62 generates a given call 70 to the corresponding original method. In some embodiments, hooked instructions 75 comprise code/instructions that wrapper 34 can add to hooked methods 76 so as to implement security feature(s) 28 by calling security service(s) 30.

While the embodiments herein described hooking original methods 66, hooking one or more application instructions (i.e., code) 62 is considered to be within the spirit and scope of the present invention. In these embodiments, application wrapper 34 (executing on processor 40) can modify (e.g., hook) a given application instruction 62 so that processor 40 executes a set of hooked instructions 75 that wrapper 34 injects into hosted software application 32.

In some embodiments, application wrapper 34 may further comprise a set of injected classes 77 having respective class IDs 79. For example, a given injected class 77 may comprise a JAVA™ SPRING filter. In these embodiments, while executing hosted software application 32, application wrapper 34 may modify application instructions 62 so as to inject (i.e., add) one or more classes 77 into hosted software application 32 (i.e., in order to add a given security feature 28 to the hosted software application).

While embodiments herein describe hooking original methods 66B in framework 64, hooking original methods 66B in any static or dynamic library used by hosted software application 32 is considered to be within the spirit and scope of the present invention.

In some embodiments, processor 40 can set hook mode flag 59 to (a first value that indicates) simulation or (a second value that indicates) production. If hook mode flag 59 is set to simulation, then upon a given hooked method 76 capturing a given call 70 to a given original method 66, the given hooked method simply calls the given original method (i.e., without any additional logic). However, if hook mode flag 59 is set to production, then upon a given hooked method 76 capturing a given call 70 to a given original method 66, the given hooked method performs one or more operations specified in the given hooked method.

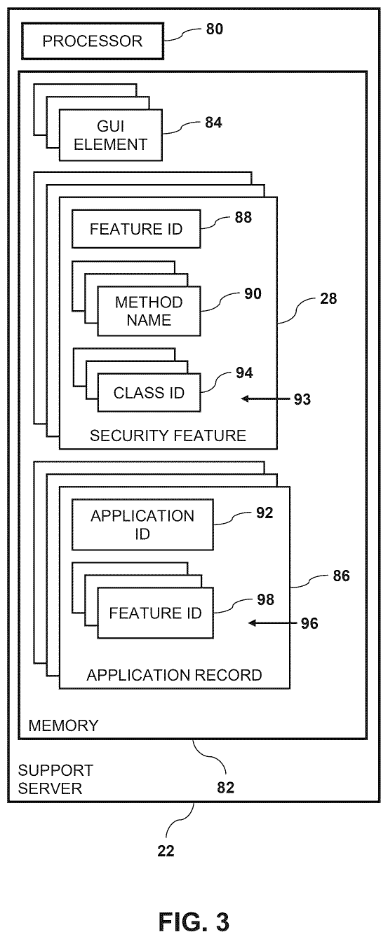

FIG. 3 is a block diagram showing an example of a configuration of management server 22, in accordance with an embodiment of the present invention. In the configuration shown in FIG. 3, management server 22 comprises a server processor 80 and a server memory 82 that can store security features 28, a set of graphical user interface (GUI) elements 84, and a set of application records 86. As described hereinbelow, processor 40 can retrieve one or more GUI elements 84 from management server 22, and use the downloaded GUI element(s) so as to generate rendering 46.

Each given security feature 28 comprises a unique security feature ID 88 a set of one or more method names 90, and code 93. In some embodiments code 93 (e.g., program instructions) may comprise a set of one or more class IDs 94 referencing respective class IDs 79. Each given method name 90 comprises a given hooked method name 78 for a given hooked method 76 that is required to implement the given security feature. In some embodiments, code 93 may be configured to call a given security service on resource server 24.

Each given application record 86 can store information such as:
An application ID 92 comprising a given application ID 60 referencing a given hosted software application 32.
A security policy 96 comprising one or more security feature IDs 98, each given security feature ID 98 comprising a given security feature ID 88. Therefore, each given security policy 96 references one or more hooked methods 76 that are required to implement the given policy.

Processors 40 and 80 comprise one or more general-purpose central processing units (CPU) or special-purpose embedded processors, which are programmed in software or firmware to carry out the functions described herein. This software may be downloaded to host computer 20 and management server 22 in electronic form, over a network, for example. Additionally or alternatively, the software may be stored on tangible, non-transitory computer-readable media, such as optical, magnetic, or electronic memory media. Further additionally or alternatively, at least some of the functions of processors 40 and 80 may be carried out by hard-wired or programmable digital logic circuits.

Examples of memories 42 and 82 include dynamic random-access memories, non-volatile random-access memories, hard disk drives and solid-state disk drives.

In some embodiments, tasks described herein performed by processors 40, 80 and resource server 24 may be split among multiple physical and/or virtual computing devices. In other embodiments, these tasks may be performed in a managed cloud service.

### Application Analysis

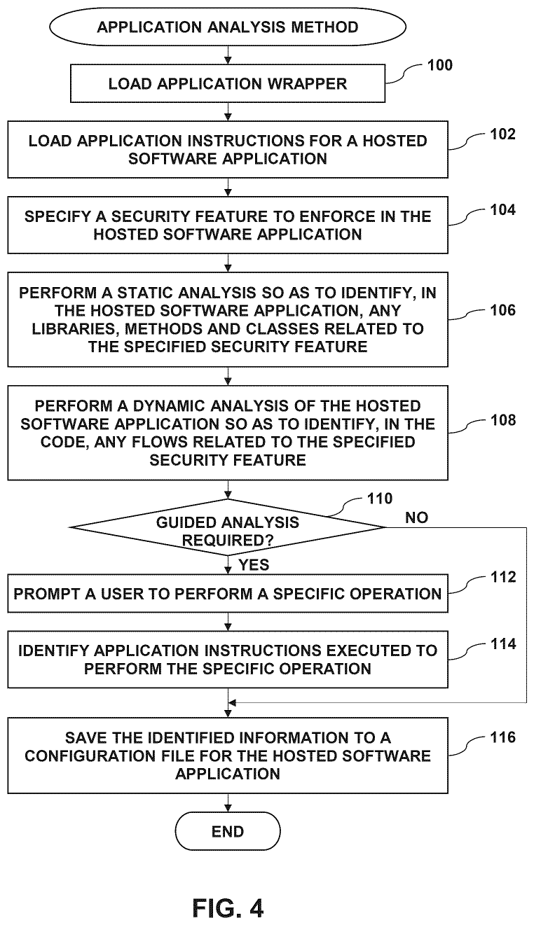

FIG. 4 is a flow diagram that schematically illustrates a method of analyzing hosted software application 32, in accordance with an embodiment of the present invention.

In step 100, processor 40 loads and initiates execution of application wrapper 34.

In step 102, application wrapper 34 loads application instructions 62, framework 64, original methods 66, and original classes 52.

In step 104, application wrapper 34 specifies (e.g., in response to input received from user 50) a given security feature 28 to enforce for hosted software application 32 executing on host computer 20.

In step 106, static analysis engine 72 (i.e., in wrapper 34) performs a static analysis on application instructions 62. In embodiments herein, the goal of the static analysis is to identify one or more application instructions 62 (e.g., in any frameworks 64, classes 52 and calls 70 to original methods 66) that are related to the specified security feature. In some embodiments, application wrapper 34 can provide hooked methods 76 that correspond to the identified methods, wherein the hooked methods can implement the given security feature.

In additional embodiments, the static analysis can identify additional information such as Uniform Resource Locators (URLs) for operation such as login/logout for authentication, user roles and all APIs for authorization, and other operations for encryption.

In step 108, processor 40 initiates execution of application instructions 62, and dynamic analysis engine 74 (i.e., in wrapper 34) performs a dynamic analysis of the executing application instructions. In embodiments herein, the goal of the dynamic analysis is to identify information (i.e., one or more instructions 62, as described in the description referencing step 106 hereinabove) that application wrapper could not discover (or discovered with some uncertainty) from any data generated by the static analysis. For example, the dynamic analysis can track operations in real-time by tracking original methods 66 that are called, and correlate operations to calls to databases and REST APIs (e.g., hosted by resource server 24).

In step 110, if a guided user/administrator analysis is requested/required, then in step 112, wrapper 34 can convey a request to browser plugin 56 to initiate a guided analysis, and in response to the request, the browser plugin can present, on display 44, a request to user 50 perform a specific operation, such as a login or changing a user role.

In step 114, browser plugin 56 monitors execution of instructions 62 while user 50 performs the requested operation, discovers instructions in the application instructions, and conveys the discovered information to application wrapper 34. For example, the application wrapper can identify any URL/parameters (i.e., in one or more application instructions 62, as described in the description referencing step 106 hereinabove) that are used to, for example, add a user and to also identify any database table or file used to store the added user information.

Finally, in step 116, upon completing the static, dynamic and guided user/administrator analyses (if necessary), application wrapper 34 can store the discovered information to configuration file 58, and the method ends. In some embodiments, configuration file 58 may store information such as (a) which application instructions 62 need to be hooked, and (b) which hooked methods 76 and injected classes 77 are required so as to implement the specified security feature in hosted software application 32.

Returning to step 110, if a guided user/administrator analysis is not requested/required, then the method continues with step 116.

In some embodiments, upon completing the steps in FIG. 4, processor 40 can convey, to management server, information such as application ID 60 and configuration data 58, which processor 80 can use to populate a given application record 86.

### Real-Time Security Enablement

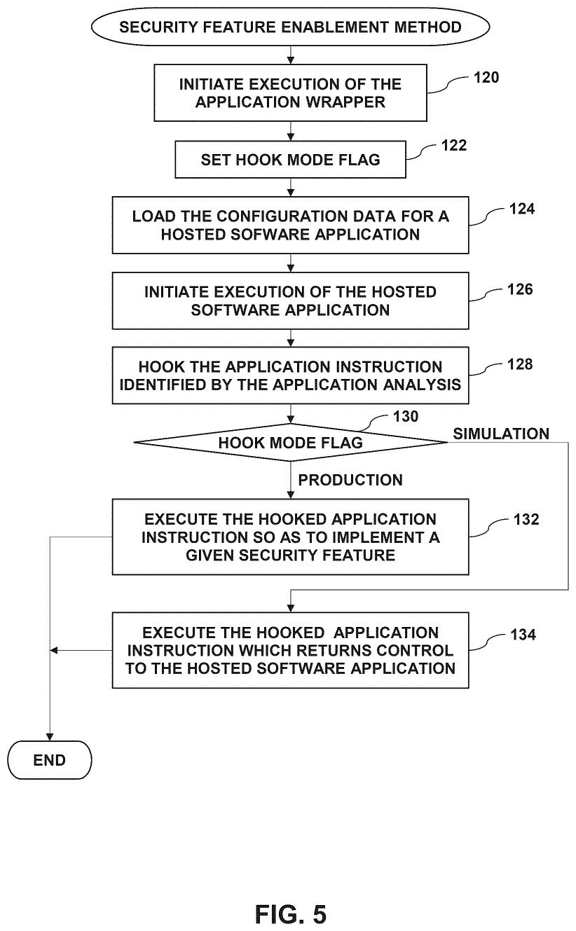

FIG. 5 is a flow diagram that schematically illustrates a method of executing hosted software application 32 with a given security feature 28 enabled via application wrapper 34, in accordance with an embodiment of the present invention. In embodiments described hereinbelow, hooked method(s) 76 comprise application instructions 62 that application wrapper 34 hooks or modifies so as to implement one or more security features 28 that can enable (for example) the hosted software application to be System and Organization Controls 2 (SOC 2) compliant.

In step 120, processor 40 loads and initiates execution of application wrapper 34.

In step 122, processor 40 sets hook mode flag 59. In some embodiments as described supra, hook mode flag 59 may indicate either simulation or production.

In step 124, processor 40 loads configuration data 58, and in step 126, the host processor loads and initiates execution of hosted software application 32.

In step 128, application wrapper 34 hooks (or modifies), in the loaded hosted software application 32, a given application instruction 62 that the static application analysis (i.e., the steps described in the description referencing FIG. 4 hereinabove) so as to implement a given security feature 28. In some embodiments, implementing a given security feature 28 may comprise a given hooked method 76 comprising code 93 that application wrapper retrieves from management server 22. As described supra, code 93 may be configured to call a given security service 30 hosted by resource server 24.

In some embodiments, the analysis performed by application wrapper 34, as described in the description referencing FIG. 4 hereinabove, may not successfully identify any application instructions that perform the specified operation. In these embodiments, application wrapper 34 can augment software application 32 by adding, to the hosted software application, additional application instructions 62 that are configured to implement the given security feature.

In step 130, application wrapper 34 checks the value stored by hook mode flag 59. If hooked mode flag 59 indicates production, then in step 132, processor 40 executes the hooked version of the identified application instruction(s) so as to implement a given security feature 28, and the method ends.

In some embodiments, the hooked version of the application instruction(s) can convey a request (e.g., an authentication request or an authorization request) to resource server 24 so as to utilize security service 30 that is configured to provide a given security feature 28.

In additional embodiments, the hooked version of the application instruction(s) may communicate with management server 22 (i.e., in addition to resource server 24) in order to implement a given security feature 28. For example, if the given feature comprises user authentication that requires user 50 to interact with a login screen, the hooked version of the application instruction(s) can retrieve, from management server 22, one or more GUI elements 84, and use the retrieved GUI element(s) to generate a login screen in rendering 46. Upon receiving login information from user 50 via rendering 46 and keyboard 48, the hooked version of the application instruction(s) can convey the login information to resource server 24 so as to enable security service 30 to authenticate user 50.

For example, the hooked version of the application instruction(s) can add a JAVA™ SPRING filter to hosted software application 32 using SPRING SECURITY. In this example, application wrapper 34 can adding the JAVA™ SPRING filter so as to redirect a login operation to an IDP server, In order for application wrapper 34 to detect all web requests and responses and to be able to modify them, the application wrapper can inject, as a new class, the JAVA™ SPRING filter which implement the javax.servlet.Filter interface.

In order to create an instance of this filter and add it to the filters chain, application wrapper 34 can hook to method getHttp( ) in class WebSecurityConfigurerAdapter (belonging to the SPRING security framework and called when processor 40 starts executing hosted software application 32 and build the SPRING security configuration). In this method, application wrapper 34 can add code that creates an instance of the JAVA™ SPRING filter class and calls http.addFilterBefore( ) to add the JAVA™ SPRING filter to the filters chain.

Returning to step 130, if hooked mode flag 59 indicates simulation, then in step 134, processor 40 executes the hooked (i.e., modified) version of the identified application instruction(s). In this embodiment, upon the hooked version of the application instruction(s) identifying that hook mode flag 59 indicates simulation, the hooked version of the application instruction(s) returns control of executing hosted software application 32 to the given application instruction, and the method ends.

While embodiments described hereinabove use hooked methods 76 having corresponding original methods 66, using these embodiments with hooked versions of classes 52 is considered to be within the spirit and scope of the present invention.

### Appendix I: Security Feature Examples

To enable hosted software application 32 to be SOC 2 compliant, application wrapper 34 can implement security features 28 (i.e., as a given security service 30) that include, but are not limited to, user authentication, user authorization, encryption and privileged access management (PAM).

In a first authentication embodiment, application wrapper 34 can add a login operation to hosted software application 32. In this embodiment, if application wrapper 34 detects the JAVA™ SPRING framework 64, and identifies the login URL and login success handler in the security configuration. In this embodiment, application wrapper 34 can search for JAVA™ SPRING security configuration code which will include building an HttpSecurity object as shown in the following example that comprises a login URL:

```
http
  .authorizeHttpRequests((requests) -> requests
    .requestMatchers(“/”, “/home”).permitAll( )
    .anyRequest( ).authenticated( )
  )
  .formLogin((form) -> form
    .loginPage(“/login”)
    .permitAll( )
```

In this case, application wrapper 34 can attach directly to JAVA™ SPRING security classes and can fully control the login flow without changing hosted software application 32 or its configuration.

In instances where JAVA™ SPRING is being used without SPRING SECURITY, application wrapper 34 can identify the login URL based on patterns in the URL and in the handler function. In this case, application wrapper 34 can attach to the servlet dispatcher and add functionality around the login operation. In both cases (i.e., with or without SPRING SECURITY), application wrapper can add a SPRING filter that is configured to modify requests and responses and to redirect browser traffic to (for example) resource server 24 providing a given service 30 (e.g., authentication).

In a second authentication embodiment, application wrapper 34 can add an identity provider (IDP) system or an Identity Governance and Administration (IGA) to hosted software application 32. For example, to add OKTA™ IDP, application wrapper 34 can detect whether or not hosted software application 32 already has OKTA™ integration for example by identifying the OKTA™ or OAUTH frameworks and by seeing the OKTA™ configuration. If application wrapper 34 detects OKTA™, application wrapper 34 can inform user 50 that OKTA™ is already integrated into hosted software application 32, and there is no need for the application wrapper to provide this authentication security feature 28.

In a third authentication embodiment, application wrapper 34 can add multi factor authentication (MFA) to hosted software application 32. Once application wrapper 34 integrates with an IDP, MFA (e.g., sending a text message) can be enabled by the IDP.

In a fourth authentication embodiment, application wrapper 34 can add single sign-on (SSO) authentication to hosted software application 32. In some embodiments, the SSO authentication can be provided by the IDP provider, and application wrapper 34 can be configured to prevent hosted software application 32 from asking for another login. For example, if there is a valid OKTA™ session, then there is no need for another login. In this example, if there is no valid application session, the application will ask for its old-style login. In instances where application wrapper 34 does not detect OKTA™, the application wrapper can simply redirect traffic from web browser 54 to OKTA™.

To implement SSO, application wrapper 34 can securely remember the users and their passwords that already logged into the application in a central database, so the application wrapper can perform a login to hosted software application 32 without showing a login page to user.

In a fifth authentication embodiment, application wrapper 34 can add passwordless authentication to hosted software application 32. In this embodiment, application wrapper 34 can integrate with a third-party authentication service 30 when application login is required so that the engine performs the authentication and validates passkeys, certificates or any other information is required to perform a login. Application wrapper 34 can integrate with a given third-party service 30 security (e.g., authentication), remember the original login and fake (and thereby prevent) the additional login to hosted software application 3.

In instances where an SSO service incorporates zero-trust security, application wrapper 34 can be configured to connect to a zero-trust service and provide, to the zero-trust service, risk information for user 50 “on behalf” of hosted software application 32.

In a sixth authentication embodiment, application wrapper 34 can add password strength enforcement to hosted software application 32. For example, password strength enforcement can specify a minimum length, a character mix, or a rotation period for passwords. In this embodiment, application wrapper 34 can keep track of users 50 and their respective passwords so as to ensure that the passwords are compliant. Although users 50 will only need to login once (i.e., in embodiments where SSO is enabled via the application wrapper), their passwords still need to be compliant.

In embodiments where password rotation is required (i.e., as a given security feature 28) and IDP and SSO are both enabled via application wrapper 34, the application wrapper can change a password on behalf of the user, since the user may not remember an old unused password.

In a first authorization embodiment, application wrapper 34 can add access control to hosted software application 32. Examples of access control include role-based access control (RBAC) and attribute-based access control (ABAC), and application wrapper 34 can base the access control on URLs, parameters and request content.

For example, if hosted software application 32 does not have any roles, then application wrapper 34 can add a role called ADMIN and only users defined as ADMINs in the IDP can be authorized to access all APIs (i.e., URLs) related to user management in the hosted software application. Since application wrapper 34 can identify all APIs coming into hosted software application 32, application wrapper 34 can block access, return an error page, or perform a redirect if the roles don't match.

In a second authorization embodiment, application wrapper 34 can add just-in-time access functionality to hosted software application 32. In this embodiment, since users 50 can login to hosted software application 32 via application wrapper 34, the application wrapper can enforce a given security policy 96 that can add limitations such as limiting specific users or specific groups of users to defined times as configured in the application wrapper. Application wrapper 34 can also specify limits according to location (assuming FW and other proxies on the way still provide the original user network address), and the application wrapper can take into account the location of the users in terms of their respective time zones.

In some embodiments, application wrapper 34 can add, to hosted software application 32, database encryption for databases supporting encryption, by detecting a database and changing the database's configuration. In these embodiments, application wrapper 34 can add support for rotating the keys or changing the key size of the web interface for hosted software application 32. For example, upon identifying the type of the database, application wrapper 34 can determine whether or not the database can support encryption, and where to find this configuration. In some embodiments, application wrapper 34 can connect between a vault and the database configuration so as to add and replace the keys.

In additional encryption embodiments, application wrapper 34 can add bring your own key (BYOK) encryption to hosted software application 32.

In further embodiments, application wrapper 34 can integrate a privileged access management (PAM) system to hosted software application 32. In these embodiments where encryption is used for a web interface and/or a database, application wrapper 34 can be configured to allow rotating the keys as well as to allow integration with vaults and PAM solutions to manage and control access (e.g., based on privileges of users, administrators and super-administrators) to “secrets” such as passwords, keys, and certificates. For example, the PAM system can manage storing and retrieving keys.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method, comprising:
specifying a security feature for a software application comprising application instructions;
analyzing the software application so as to identify a given application n for modification so as to implement the security feature;
implementing, by a processor in response to analyzing the software application, the specified security feature by modifying the identified application instruction; and
initiating execution of the software application with the modified application instruction.

2. The method according to claim 1, wherein modifying the identified application instruction comprises hooking the identified application instruction so as to call code implementing the specified security feature.

3. The method according to claim 2, wherein hooking the identified application instruction comprises deploying a hooked method to the software application.

4. The method according to claim 3, wherein deploying the hooked version of the given application instruction comprises injecting a class to the software application.

5. The method according to claim 1, wherein the steps of analyzing the software application and modifying the given instruction are performed by an application wrapper executing on the processor.

6. The method according to claim 5, wherein the software application and the application wrapper execute on a first computer comprising the processor, and wherein the code implementing the specified security feature executes on a second computer.

7. The method according to claim 1, wherein analyzing the software application comprises performing a static analysis of the application instructions.

8. The method according to claim 1, wherein analyzing the software application comprises performing a dynamic analysis of the application instructions.

9. The method according to claim 1, wherein analyzing the software application comprises performing a guided analysis of the application instructions.

10. The method according to claim 1, wherein implementing the security feature comprises modifying, by the processor in response to analyzing the software application, the identified application instruction as so to add authentication to the software application.

11. The method according to claim 10, wherein adding the authentication comprises modifying, by the processor in response to analyzing the software application, the identified application instruction so as to add a login operation to the software application.

12. The method according to claim 10, wherein adding the authentication comprises modifying, by the processor in response to analyzing the software application, the identified application instruction so as to integrate an identity provider (IDP) system with the software application.

13. The method according to claim 10, wherein adding the authentication comprises modifying, by the processor in response to analyzing the software application, the identified application instruction so as to add multi factor authentication (MFA) to the software application.

14. The method according to claim 10, wherein adding the authentication comprises modifying, by the processor in response to analyzing the software application, the identified application instruction so as to add single sign-on (SSO) to the software application.

15. The method according to claim 10, wherein adding the authentication comprises modifying, by the processor in response to analyzing the software application, the identified application instruction so as to add passwordless authentication to the software application.

16. The method according to claim 10, wherein adding the authentication comprises modifying, by the processor in response to analyzing the software application, the identified application instruction so as to add Identity Governance and Administration software (IGA) to the application.

17. The method according to claim 10, wherein adding the authentication comprises modifying, by the processor in response to analyzing the software application, the identified application instruction so as to add password strength enforcement to the software application.

18. The method according to claim 1, wherein implementing the security feature comprises modifying, by the processor in response to analyzing the software application, the identified application instruction so as to add authorization to the software application.

19. The method according to claim 18, wherein adding the authorization in comprises modifying, by the processor response to analyzing the software application, the identified application instruction so as to add access control to the software application.

20. The method according to claim 19, wherein adding the access control comprises modifying, by the processor in response to analyzing the software application, the identified application instruction so as to add role-based access control (RBAC) to the software application.

21. The method according to claim 19, wherein adding the access control comprises modifying, by the processor in response to analyzing the application, software the identified application instruction so as to add attribute-based access control (ABAC) to the software application.

22. The method according to claim 18, wherein adding the authorization comprises modifying, by the processor in response to analyzing the software application, the identified application instruction so as to add just-in-time access functionality to the software application.

23. The method according to claim 1, wherein implementing the security feature comprises modifying, by the processor in response to analyzing the software application, the identified application instruction so as to add, to the software application one or more keys for encryption.

24. The method according to claim 23, wherein adding the one or more for encryption comprises modifying, by the processor in response to analyzing the software application, the identified application instruction so as to add rotating the keys to the software application.

25. The method according to claim 23, wherein adding the one or more keys for encryption comprises modifying, by the processor in response to analyzing the software application, the identified application instruction so as to add changing a size of a given key to the software application.

26. The method according to claim 23, wherein adding the one or more keys for encryption comprises modifying, by the processor in response to analyzing the software application, the identified application instruction so as to add bring your own key (BYOK) encryption to the software application.

27. The method according to claim 1, wherein implementing the security feature comprises modifying, by the processor in response to analyzing the software application, the identified application instruction so as to connect to a privileged access management (PAM) service.

28. The method according to claim 1, wherein identify a given application instruction comprises identifying a lack of such an application instruction, and wherein modifying the application instruction comprises adding an additional application instruction to the software application.

29. An apparatus, comprising:
a memory configured to store a software application comprising application instructions; and
a processor configured:
to specify a security feature for the software application,
to analyze the software application so as to identify a given application instruction for modification so as to implement the security feature,
to implement, in response to analyzing the software application, the specified security feature by modifying the identified application instruction, and
to initiate execution of the software application with the modified application instruction.

30. A computer software product, the computer software product, comprising a non-transitory computer-readable medium, in which program instructions are stored, which instructions, when read by a computer, cause the computer:
to specify a security feature for a software application comprising application instructions;
to analyze the software application so as to identify a given application instruction for modification so as to implement the security feature;
to implement, in response to analyzing the software application, the specified security feature by modifying the identified application instruction; and
to initiate execution of the software application with the modified application instruction.
